(19) United States
(12) Patent Application Publication
(10) Pub. No.: US 2025/0094473 A1
(43) Pub. Date: Mar. 20, 2025

(54) SYSTEMS AND METHODS FOR WINDOWED SUMMARIZATIONS OF EVENT LOGS

(71) Applicant: Palantir Technologies Inc., Denver, CO (US)

(72) Inventor: Peter Wilczynski, San Francisco, CA (US)

(21) Appl. No.: 18/884,951

(22) Filed: Sep. 13, 2024

Related U.S. Application Data
(60) Provisional application No. 63/539,186, filed on Sep. 19, 2023.

(51) Int. Cl. G06F 16/34

(52) U.S. Cl. CPC G06F 16/345

(57) ABSTRACT

Devices, systems, and methods for generating summaries are disclosed. In some implementations, a method can include receiving a plurality of event logs, at least one event log of the plurality of event logs including unstructured data and a corresponding event time. In addition, the method can include generating a series of event logs according to event times of the plurality of event logs. The method can include receiving a time window of interest corresponding to one or more event logs in the generated series of event logs. Moreover, the method can include generating a text summary by applying a language model to unstructured data corresponding to the one or more event logs in the time window of interest. Also, the method can include transmitting the text summary to a computing device.

### 1. CROSS REFERENCE TO RELATED APPLICATIONS

This application claims priority to U.S. Provisional Application No. 63/539,186, filed Sep. 19, 2023, incorporated by reference herein for all purposes.

### 2. TECHNICAL FIELD

Certain embodiments of the present disclosure are directed to computing systems and methods for generating summaries. More particularly, some embodiments of the present disclosure provide systems and methods for generating a summary from event logs.

### 3. BACKGROUND

Transforming event logs into consumable time series objects is valuable, but challenging. In some examples, any datasets involve numerous low-degree events linked to a smaller number of high-degree entities. For example, these events are hard to analyze, pollute graph visualizations of entities and relationships, sometimes referred to as creating a metrics layer. In certain examples, when associating timeseries with object types, data is ingested as event logs and metrics are derived from these logs and linked to entities to be characterized. Unlike in a simple sensor-based time-series workflow, metrics come in as discrete events, not as well-formed series. Because this transformation is onerous, it is seldom done.

Hence it is highly desirable to improve techniques for improving the techniques in generating a consumable transformation.

### 4. SUMMARY

Certain embodiments of the present disclosure are directed to computing systems and methods for generating summaries. More particularly, some embodiments of the present disclosure provide systems and methods for generating a summary from event logs.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In a general aspect, a method can include receiving a plurality of event logs, at least one event log of the plurality of event logs including unstructured data and a corresponding event time. The method can include generating a series of event logs according to event times of the plurality of event logs. The method can furthermore include receiving a time window of interest corresponding to one or more event logs in the generated series of event logs. The method can in addition include generating a text summary by applying a language model to unstructured data corresponding to the one or more event logs in the time window of interest. The method can moreover include transmitting the text summary to a computing device. The method can include where the method is performed using one or more processors. Other embodiments of this aspect include corresponding computer systems, apparatus, and computer programs recorded on one or more computer storage devices, each configured to perform the actions of the methods.

In another general aspect, a system can receive a plurality of event logs, at least one event log of the plurality of event logs including unstructured data and a corresponding event time. The system can also generate a series of event logs according to event times of the plurality of event logs. The system can furthermore receive a time window of interest corresponding to one or more event logs in the generated series of event logs. The system can in addition generate a text summary by applying a language model to unstructured data corresponding to the one or more event logs in the time window of interest. The system can moreover transmit the text summary to a computing device. Other embodiments of this aspect include corresponding computer systems, apparatus, and computer programs recorded on one or more computer storage devices, each configured to perform the actions of the methods.

In another general aspect, non-transitory computer-readable mediums may include one or more instructions that, when executed by one or more processors of a device, cause the device to: receive a plurality of event logs, at least one event log of the plurality of event logs including unstructured data and a corresponding event time; generate a series of event logs according to event times of the plurality of event logs; receive a time window of interest corresponding to one or more event logs in the generated series of event logs; generate a text summary by applying a language model to unstructured data corresponding to the one or more event logs in the time window of interest; and transmit the text summary to a computing device; receive an entity of interest relating to the plurality of event logs. non-transitory computer-readable mediums may include one or more instructions that, when executed by one or more processors of a device, cause the device to select the one or more event logs from the plurality of event logs based at least in part on the entity of interest. Such aspects include where the entity of interest is at least one selected from a group having of a person, a team, a task, a project, an event, a situation, and an initiative. Other embodiments of this aspect include corresponding computer systems, apparatus, and computer programs recorded on one or more computer storage devices, each configured to perform the actions of the methods.

### 5. BRIEF DESCRIPTION OF THE DRAWINGS

Depending upon embodiment, one or more benefits may be achieved. These benefits and various additional objects, features and advantages of the present disclosure can be fully appreciated with reference to the detailed description and accompanying drawings that follow.

FIG. 1 is a simplified diagram showing a method for text summarization of one or more event logs according to one embodiment of the present disclosure.

FIG. 2 is a simplified diagram showing a method for generating a text summary of one or more event logs according to one embodiment of the present disclosure.

FIG. 3A is an illustrative example workflow for a system to generate a text summary from a plurality of event logs according to one embodiment of the present disclosure.

FIG. 3B is an illustrative example workflow for a system to generate a text summary recursively from a series of previously generated text summaries and a plurality of event logs according to one embodiment of the present disclosure.

FIG. 4 is an illustrative example of a computing environment for generating text summaries, according to one embodiment of the present disclosure.

FIG. 5 is a simplified diagram showing a computing system for implementing a system for generating text summaries from event logs in accordance with at least one example set forth in the disclosure.

### 6. DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to certain embodiments, organizational communication patterns include established methods of summarizing one or more events (e.g., meeting summaries, quarterly updates, annual reports, etc.) as a mechanism of information compression for information consumers. In certain embodiments, this established summarization process provides the dual benefit of maintaining information consumers situational awareness of multiple activities while also preventing information consumers from being overwhelmed by the massive amount of available data. In some examples, the established summarization process may include deriving time series information from one or more pieces of data relating to an event.

According to certain embodiments, the established summarization process was limited to generating output based on numeric data such as numeric operations (e.g., counts, averages, maximum values, minimum values, etc.). In some examples, the established summarization process had difficulty incorporating the substantive content of unstructured data (e.g., the content of text messages, code commits, chat messages, emails, and other textual data) into the generated output. For example, an established summarization process may be able to receive a textual document such as a meeting transcript and provide a summarization of the word count or character count (e.g., the numeric structured data) but not generate output summarizing the content of the meeting based on the text of the document (e.g., the unstructured data). In some examples, the usefulness of the established summarization process is limited, especially when considered in terms of the voluminous amounts of unstructured data available to information consumers.

According to some embodiments, systems and methods of the present disclosure are directed to generating a text summary from one or more event logs containing unstructured data and/or structured data using one or more computing models (e.g., one or more language models). In certain embodiments, a computing model, also referred to as a model, includes a model to process data. In certain embodiments, a model includes, for example, an AI model, a machine learning (ML) model, a deep learning (DL) model, an image processing model, an algorithm, a rule, other computing models, a large language model (LLM), and/or a combination thereof. In certain embodiments, systems and methods of the present disclosure are directed to generating a text summary from one or more event logs containing unstructured and/or structured data using one or more LLMs.

According to certain embodiments, a language model is a computing model that can predict the probability of a series of words, for example, based on the text corpus on which it is trained. In some embodiments, a language model can infer word probabilities from context. In some embodiments, a language model can generate word combinations (and/or sentences) that are coherent and contextually relevant. In certain embodiments, a language model can use a computing model that has been trained to process, understand, generate, and manipulate language. In some embodiments, a language model can be useful for natural language processing, including receiving natural language prompts and providing natural language responses, speech recognition, natural language understandings, and/or the like. In certain embodiments, a language model includes an n-gram, exponential, positional, neural network, and/or other type of model.

According to some embodiments, a large language model (“LLM”) is a type of language model that has been trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

According to some embodiments, the generated text summary from the computing model (e.g., the language model) includes a summary of the substantive content of one or more pieces of unstructured data and/or structured data in addition to the numeric content thereby improving on the established summarization process. In some embodiments, an event log is a record of the occurrence of an event with a corresponding event time (e.g., a date and time stamp). In some embodiments, an event log contains one or more unstructured data and/or structured data. In some embodiments, unstructured data is data that does not have a predetermined data model or a predetermined data schema. In some embodiments, the unstructured data is human generated and/or machine generated. In some examples, the unstructured data includes textual data, non-textual data, one or more alphanumeric characters, a text message, a code commit, a chat message, an email, a document, a transcript, a server log, a website log, an application log, sensor data, image data, audio data, video data, social media data, mobile data, and/or other machine data. In some embodiments, structured data is data that conforms to a predetermined data model, a standardized format, or a well-defined structure. In some examples, structured data includes numeric data, banking data, transaction data, an organized listing of identifying information (e.g., names, addresses, email addresses, etc.), data graphs and charts, serial numbers, and/or other data that conforms to a standardized format. In certain embodiments, structured data includes data stored in a database, data in a defined data field with data types, and/or the like.

According to some embodiments, an event log is linked to multiple entities which can be utilized to further refine the analysis for certain information consumers. In some embodiments, an entity is a type of semantic object such as, for example, a user, a person, a team, a task, an initiative, a customer, a geographic location, a building, a project, a workflow, a product, and/or the like. In certain embodiments, an entity is separated from but connected to one or more event logs. In some embodiments, the one or more event logs can be a part of a structural framework including many event logs and other data related to the organization.

According to certain embodiments, the system receives one or more event logs which is organized into a series of event logs based on the event time and/or recording time. In some embodiments, the series of event logs is windowed into one or more windows of interest as sub-sections of the larger series of event logs. In certain embodiments, a window of interest, also referred to as a time window of interest, refers to a window of time including a start time and an end time. In some embodiments, a windowed series of event logs refers to a series of event logs having corresponding event time and/or recording time within the window of interest. In some examples, the underlying unstructured and/or structured data of the windowed series of event logs is applied to a computing model with a natural language prompt. In some examples, the computing model (e.g., the language model) generates one or more text summary outputs based on the windowed series of event logs and transmit them to a computing device, such that, for example, compressing the underlying data of the event logs into a smaller text summary.

According to certain embodiments, the one or more generated text summaries are utilized as subsequent input to the computing model (e.g., the language model) to generate additional higher level text summaries (e.g., shorter in size, specific in subjects, etc.). In some embodiments, the one or more generated text summaries are utilized recursively as subsequent input to the computing model to generate additional higher level text summaries. In some examples, the recursive process includes inputting the previously generated text summary in combination with one or more event logs containing unstructured data and/or structured data. In certain examples, generating recursive text summaries (e.g., daily, weekly, monthly, etc.) provides the benefit of creating text summaries including different windows aggregated for different information consumers. In some examples, this allows information consumers to consume more aggregated text summaries while still retaining the ability to highlight and analyze particular topics of interest at a granular level by retaining the underlying event logs with the text summaries.

According to certain embodiments, an event log is related to multiple entities, for example, five (5) entities. In some examples, as the event logs are collected over time it becomes apparent that across a windowed series of event logs, the majority of the event logs are connected to the same and/or similar entities. In certain examples, an entity of interest is identified and used in combination with the event logs and natural language prompt to create a targeted prompt directed to the entity of interest. In some examples, in some examples the targeted prompt is applied to a computing model to generate one or more text summaries related to that entity of interest.

In some examples, a user provides as input to the computing model (e.g., the language model) work chat messages windowed to a period of time (e.g., one month) including a number of messages (e.g., over 200 messages about 4000 words). In some examples, each chat message corresponds to an event log of unstructured data with an event time of when the message was transmitted. In certain examples, the user includes a natural language prompt such as “summarize important topics, discussions, and decisions from the team over the past month” in addition to the event logs. In some examples, the computing model (e.g., the language model) generates a text summary of the chat messages in a number of words (e.g., around 100 words), for example, discussions of replacing and improving certain aspects of a project, a decision for a new branding option, and open questions still remaining to be answered, and/or other similar items. In some examples, the resulting text summary has a semantic compression ratio (e.g., 30 times) from the words in the event logs. In certain examples, the resulting text summary has a significant temporal compression ratio from the time duration of the event logs, for example, almost 40,000 times temporal compression ratio such that one month of team communications can be consumed by an information consumer in about a single minute. In some examples, this is a significant improvement over the established summarization method in terms of substantive content quality as well as a reduction in labor costs to produce an equivalent text summary.

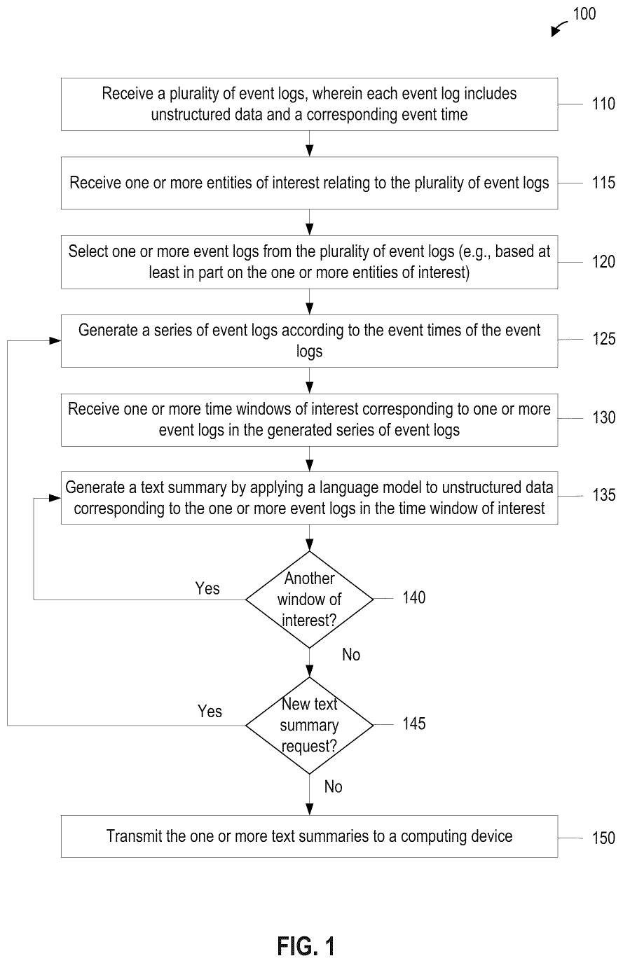

FIG. 1 is a simplified diagram showing a method 100 for text summarization of one or more event logs according to certain embodiments of the present disclosure. FIG. 1 is merely an example. One of ordinary skill in the art would recognize many variations, alternatives, and modifications. The method 100 for generating a text summary from one or more event logs includes processes 110, 115, 120, 125, 130, 135, 140, 145, and 150. Although the above has been shown using a selected group of processes for the method 100 for generating text summaries, there can be many alternatives, modifications, and variations. For example, some of the processes are expanded and/or combined. Other processes are inserted into those noted above. Depending upon the embodiment, the sequence of processes are interchanged with others and/or replaced. Further details of these processes are found throughout the present disclosure.

According to certain embodiments, some or all processes (e.g., steps) of the method 100 are performed by a system (e.g., the computing system 500). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at the process 110, a processor (e.g., processor 420) receives a plurality of event logs. In some embodiments, an event log includes one or more of unstructured data, structured data, and/or a corresponding event time indicating when the event log occurred. In some embodiments, unstructured data is data that does not have a predefined data model, a predefined data schema, a standardized format or a well-defined structure. In some examples, unstructured data includes textual data, non-textual data, one or more alphanumeric characters, a text message, a code commit, a chat message, an email, a document, a transcript, a server log, a website log, an application log, sensor data, image data, audio data, video data, social media data, mobile data, and/or other machine data and/or a combination of such unstructured data. In some embodiments, structured data is data that conforms to a predefined data model, a predefined data schema, a standardized format or a well-defined structure. In some examples, structured data includes numeric data, banking data, transaction data, an organized listing of identifying information (e.g., names, addresses, email addresses, etc.), data graphs and charts, serial numbers, and/or other data that conforms to a standardized format (e.g., storable in a database).

In some embodiments, the event time includes a date and time stamp that indicates a single date and time that an event occurred. In some embodiments, the event time includes a date and time range indicating that the event occurred over that period of time (e.g., a 3-day conference event). In some embodiments, the event time is presented in a plurality of formats one having skill in the art would understand.

According to certain embodiments, the one or more received event logs are linked to one or more entities that are connected to the event log in some way. In some embodiments, an entity is a type of semantic object that exists within an ontology such as a user, a person, a team, a task, an initiative, a customer, a geographic location, a building, a project, a workflow, a product, and/or other types of semantic objects linked to the event log. In some examples, an event log has one or a few entities linked to it, such as a certain task that is related to a specific team and/or product. In certain examples, an event log has many entities linked to it such as a national conference with thousands of people attending.

According to certain embodiments, at process 115, a processor (e.g., processor 420) receives one or more entities of interest, for example, entities relating to the plurality of event logs. In some embodiments, an entity is received as a potential focus of a request for a text summary by a user. In some embodiments, the event logs received could be related to an airline company having delayed flights over the past six months. In some examples, the entity of interest could be a specific location such as a certain airport or group of airports. In certain examples, the entity of interest could be a semantic object related to the event logs such as a specific reason for delayed flight (e.g., weather delay, maintenance delay, ground support delay, etc.), a request to look at where delayed flights were rerouted to, or a request for entities linked to event logs with a delay exceeding 2 hours among a plurality of other possible entities. In some embodiments, multiple entities of interest are received relating to the event logs. In some examples, where multiple entities of interest are received the entities are related to each other in some way. In certain examples, where multiple entities of interest are received, the entities are not related to each other.

According to certain embodiments, at process 120, one or more event logs from the plurality of event logs are selected using a computing device (e.g., computing device 440A). In some embodiments, the one or more event logs are selected based at least in part on the one or more entities of interest received at process 115. In some embodiments, all and each of the selected one or more event logs are linked to the one or more received predetermined entities of interest.

According to certain embodiments, at process 125, a series of event logs is generated by processor (e.g., processor 420) according to the event times of the one or more selected event logs. In some embodiments, if no event logs are specifically selected, the generated series of event logs will be generated from the one or more received event logs. In some embodiments, the series of event logs is generated by arranging the event logs according to the event time corresponding to the event log respectively. In some examples, the generated series is sequential, first to last or last to first for the event logs.

According to certain embodiments, at process 130, one or more time windows of interest are received by a computing device (e.g., computing device 440A) corresponding to one or more of the event logs in the generated series of event logs. In some embodiments, the time window of interest could be a unit of time that includes one or more event logs from the series of event logs. In some examples, the time window of interest is an hour, a few hours, a day, a week, a month, a year, or longer as required by the user. In some examples, the time window is specified with a specific date and/or time range with certain starting and ending points. In certain embodiments, the time windows could be randomly applied to the event logs (e.g., three different windows of three hours length for each window within the last two weeks). In some examples, a first time window is specified to have a first length, a second time window has a second length different than the first length, a third time window is specified with a third length different from the first and second lengths, and so on based on the needs of the user.

According to certain embodiments, the benefit of windowing becomes apparent by considering that the event log series itself is discontinuous meaning the data is collected as unstructured data that is difficult to easily categorize and is not provided on a regular time basis. In some examples, the collection occurs at varying time intervals such as once a week, once a month, or longer, and in the aggregate, it is not easy to containerize these disparate unstructured data sets for analysis. In some examples, windowing organizes the event logs thereby improving the generated text summaries.

According to certain embodiments, at process 135, a text summary is generated by applying a language model (e.g., computing model 450, a language model, an LLM, etc.) to unstructured data corresponding to the one or more event logs in the time window of interest. In some embodiments, the prompt to the LLM includes unstructured data underlying the one or more event logs in the window of interest. In some embodiments, the prompt to the LLM includes a combination of structured and unstructured data from the one or more event logs in the window of interest. In some embodiments, the event log series is provided to the LLM as a prompt. In some embodiments a combination of one or more of the unstructured data, structured data, and/or event log series is provided to the LLM as a prompt. In some embodiments, the prompt to the LLM includes a natural language prompt specifying an entity of interest and or a topic of interest that is the subject of the summary in addition to one or more of the unstructured data, structured data, and/or event log series data. In some embodiments, the output of the computing model is one or more text summaries of the data input with the prompt. In some examples, the text summary is organized as structured data with a format corresponding to the one or more windows applied to the data as part of the prompt. In some examples, the text summary includes unstructured data such as unorganized text in a summary. In some examples, the text summary includes structured data such as organized text (e.g., in a spreadsheet, in a table) and/or a numeric attribute in a summary. In some examples, the text summary includes a combination of unstructured and structured data. In some examples, the text summary includes one or more metrics corresponding to the data input via the prompt. In some embodiments, the text summary includes specific information relating to the specified entity of interest.

According to certain embodiments, process 140 is a decision operation determining if another window of interest is provided. In some embodiments, if multiple windows of interest are received by the computing device (e.g., computing device 440) the process branches yes and returns to process 135 where another text summary is generated corresponding to the additional time window of interest. In some embodiments, if there are no additional time windows of interest the process branches no and progresses to process 145.

According to certain embodiments, process 145 is a decision operation determining if a new text summary request is received by the computing device (e.g., computing device 440). In some embodiments, a new text summary request is received and the process branches yes to return to process 125. In some examples, the new request is a recursive request to generate a series of text summaries based on the previously generated text summaries from process 135 and/or additionally identified event logs. In some embodiments, where the previously generated text summaries include unstructured data, the series of summaries forms a new series of event logs that are at a higher level than the previously generated series of event logs. In some embodiments, if the previously generated summaries include only structured data the new series of summaries forms a new time series. In some embodiments, the process progresses through processes 125, 130, 135, and 140 as previously described with the addition of the previously generated summaries as potential data to include in the prompt with one or more of the series of event logs, structured data, unstructured data, and natural language prompt.

According to certain embodiments, the recursive process provides a simplified method of using the same underlying data to recursively generate subsequent text summaries. In some embodiments, performing analysis and generating text summaries for the different windows and different levels of a hierarchical structure provides additional semantic meaning to the user which is absent from a single time series summary. For example, generating a text summary of the cost per minute of a series of event logs may not provide sufficient insight, but aggregating the cost per minute to higher level text summaries such as the cost per hour or cost per day level could. In some embodiments, this is not be apparent until after the original text summaries at the lower level are generated and then recursively aggregated to the higher level. In some embodiments, the generated text summaries remain connected to the event logs and underlying unstructured data and/or structured data. In some examples, this provides the benefit that even throughout multiple recursive iterations it is still possible to access and utilize the underlying data if requested by a user or information consumer.

According to certain embodiments, if there is no new text summary request at process 145, the process branches no to process 150 where the one or more text summaries are provided to a computing device (e.g., computing device 440).

According to certain embodiments, the system can determine usage analytics. In some embodiments, a business has a variety of products and the products have different versions. In some examples, the products are a big software product Alpha, a smaller software product Beta within the larger product Alpha, and software product Zeta which is a smaller product within Beta. In some examples, if a user performs an action with Zeta, they are simultaneously also using Alpha and Beta and generating corresponding event logs at each product level, even though the input was provided to Zeta. In certain examples, the input is the event log, and the entities attached are Zeta, Alpha, and Beta as well as at least the identification data of who the user is (e.g., an employee, a customer, a third-party service provider, etc.) and other entities. In some examples, the events that occur in Zeta are provided as an event log series and recursively aggregated to generate text summaries relating to the entity of interest as Alpha or Beta.

According to some embodiments, a benefit of the text summary is that it compresses large amount of data (e.g., terabytes of information), via the process of windowing and analyzing the unstructured data using a computing model, into a text summary that is much smaller in size (e.g., tens of megabytes or less). In some embodiments, thousands of times of compression for the unstructured data underlying the event log is produced into a text summary as a time series. In some examples, the compression is considered lossy compression of the event logs and the associated and/or embedded unstructured data. In certain examples, the compression is defined as lossless if the event logs and underlying unstructured data are maintained because the user would be able to re-use the data. In some examples, the text summary becomes a record of unstructured data that would otherwise be lost. In certain examples, this provides additional benefits in trend analysis and understanding changes over time. In some examples, the application of the computing model provides text summaries that are not biased.

According to certain embodiments, another benefit is that the computing model enables the use of the graph representation of the unstructured data to construct a text summary as a time series. In certain embodiments, this is used to generate one or more reporting documents (e.g., monthly summaries, annual reports, etc.) recursively. In some examples, the system is used for diagnostics and debugging of computer systems and computer code.

According to some embodiments, the system can provide summarization of specific projects and/or topics relating to a business. In some embodiments, a business manager wants to answer two questions concurrently about the capabilities of the current organization such as which individuals are subject matter experts on a topic X and which members of the organization are responsible for projects related to topic X over the past year. In some examples, event logs containing unstructured data relating to topic X such as meeting notes, emails, chats, documents, and/or audio-video recordings are collected. In some examples, the unstructured data is windowed to cover the past year and provided as a prompt along with a natural language prompt including the two questions to the computing model. In some examples, the computing model provides a text summary answering the two questions as time series information over the past year based on the unstructured data. In some examples, the benefit of such a system includes for example, identifying if the subject matter expert and person responsible for a project are the same and/or different people, if there are subject matter gaps in the organization, and assisting with identifying human capital capacity within the organization.

According to certain embodiments, collecting event logs, unstructured data, and/or structured data involves one or more vector embedding systems including a vector embedding generator and one or more vector embedding databases.

According to certain embodiments, the event logs and underlying unstructured data is used to improve the response to recurring but infrequent support issue in a workflow. In some examples, the response to the workflow is recorded as a series of event logs including an event time (e.g., date and time stamp) for the occurrence of the event log and unstructured data underlying the event log. In some examples the unstructured data includes which people were contacted for the problem, the means of communication (e.g., email, chat, voice call, etc.), and the responses from each individual eventually leading to a resolution. In some examples, the event logs are provided with the additional prompt “optimize the response to the issue” to a computing model which can generate a text summary for how to optimize the workflow.

According to certain embodiments, the system can be used to generate and track customer success metrics. In some embodiments, the success metric can be generated based on the event logs relating to a plurality of customer interactions over time. In some embodiments, the event logs include unstructured data from call recordings, transcripts, customer calls, and online survey responses. In some examples, sentiment analysis could be performed as tied to significant events that occurred as windowed events within a relevant time period, to generate one or more quantitative customer success metrics. In some examples, the comparison of quantitative metrics tied to a natural disaster that caused delayed service versus an operational issue that caused delayed service is an insight that is otherwise missed.

According to certain embodiments, the event logs could be related to one or more pieces of media (e.g., news articles, online social media posts, audio and video recordings, etc.) as unstructured data relating to multiple different news topics from multiple different countries over the past three years. In some embodiments, these event logs would necessarily include event times corresponding to the unstructured data. In some examples, a user wants to understand the top three news stories on a per-country basis for a certain window of time (e.g., monthly, quarterly, etc.). In some examples, the event logs could be windowed for a certain time frame, combined with a natural language prompt specifying individual text summaries for five different countries, and the underlying unstructured data corresponding to the event logs could be applied to a computing model. In certain examples, a user could recursively reenter the text summaries with a subsequent natural language prompt to identify the top three news stories and ask for stance annotation on a per-country basis for countries that share common top news stories. In some examples, the resulting text summary would provide the stance associated with each top news story on a country-by-country basis. In some examples, the original and subsequent requests are recursively performed on the same event log series and underlying unstructured and/or structured data.

According to some embodiments, event logs with corresponding unstructured data are collected relating to code commits for a certain product. In some embodiments, the unstructured data as an event log could be tied to a plurality of entities including one or more product features, one or more people, type of commit, etc. In some embodiments, additional event time information is collected relating to when commits are made, how many commits are made, how many lines of code are committed, and even down to the metadata level associated with the code commit. In some examples, the event logs could be windowed into hours of the day and provided to the computing model with a natural language prompt for which hours of each day of the week have the most code commits and a resulting text summary is output by the computing model. In some examples, the initial text summary could be recursively applied to the computing model with the unstructured data to identify a plurality of metrics such as who is making commits, at what time are they made, which days have the highest commit rate, which products have higher or lower commit rates, when a team of people are providing code commits, what was the purpose of a code commit at an unusual time, why was one person inputting so many code commits as compared to another person, etc.

According to certain embodiments, one or more event logs are collected from unstructured data relating to investment opportunities. In some embodiments, the corresponding unstructured data includes press releases, audio and video data from quarterly earnings calls, blogs, daily average stock prices, and other documents relating to investments. In some examples, the unstructured data is applied to a computing model with a prompt asking for a text summary of the event logs relating to the investment opportunity over a certain time window. In some examples, the generated text summaries are recursively applied to test an investment thesis, compare multiple companies' performance over the recent past, discover investment trends over time, etc.

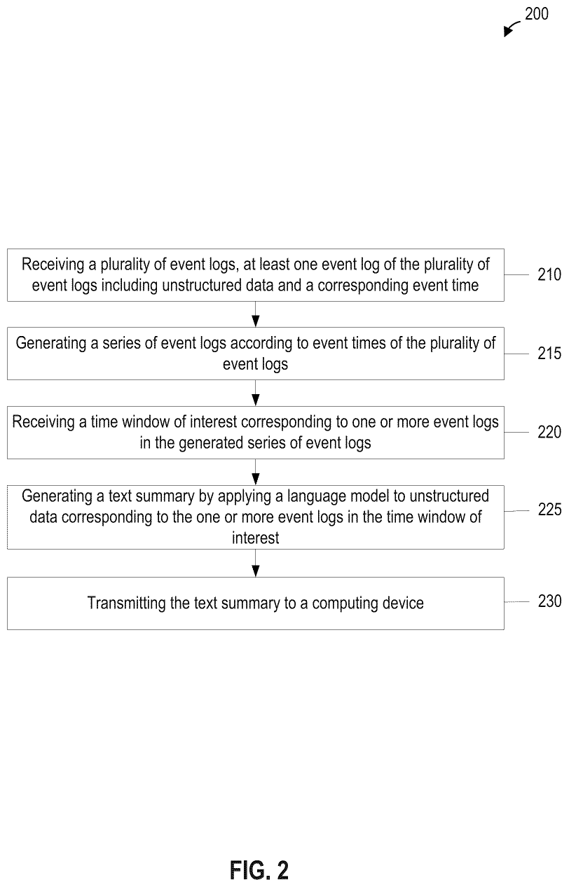

FIG. 2 is a simplified diagram showing a method 200 for generating a text summary of one or more event logs according to certain embodiments of the present disclosure. This diagram is merely an example. One of ordinary skill in the art would recognize many variations, alternatives, and modifications. The method 200 includes processes 210, 215, 220, 225, and 230. Although the above has been shown using a selected group of processes for the method 200 for generating text summaries, there can be many alternatives, modifications, and variations. For example, some of the processes are expanded and/or combined. Other processes are inserted into those noted above. Depending upon the embodiment, the sequence of processes is interchanged with others and/or replaced. Further details of these processes are found throughout the present disclosure.

In some embodiments, some or all processes (e.g., steps) of the method 200 are performed by a system (e.g., the computing system 500). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 210, a computing device (e.g., computing device 440) receives a plurality of event logs. In some embodiments, at least one event log of the plurality of event logs includes unstructured data and a corresponding event time for the event log.

According to certain embodiments, at process 215, a processor (e.g., processor 420) generates a series of event logs from the plurality of received event logs. In some embodiments, the series of event logs is generated according to the event times of the plurality of event logs.

According to certain embodiments, at process 220, a computing device (e.g., computing device 440) receives a time window of interest corresponding to one or more event logs in the generated series of event logs.

According to certain embodiments, at process 225, a text summary is generated by applying a language model (e.g., computing model 450, an LLM, etc.) to unstructured data corresponding to the one or more event logs in the time window of interest from process 220. In some embodiments, the prompt to the computing model includes one or more of a natural language prompt, unstructured data, structured data, a previously generated text summary, and/or the event log series.

According to certain embodiments, at process 230, the text summary is transmitted to a computing device (e.g., computing device 440).

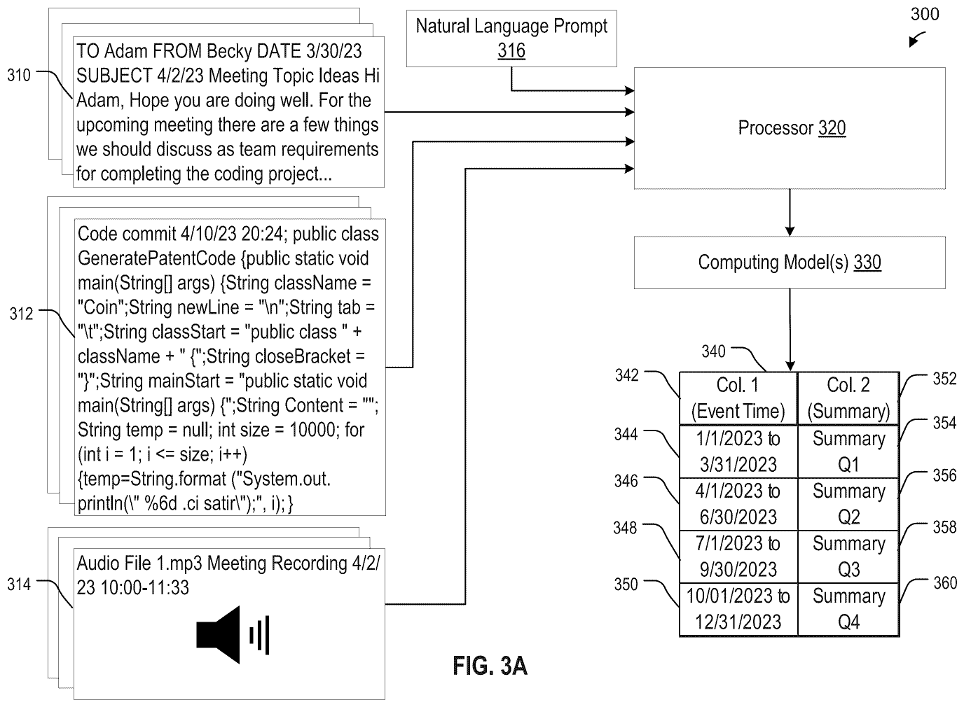

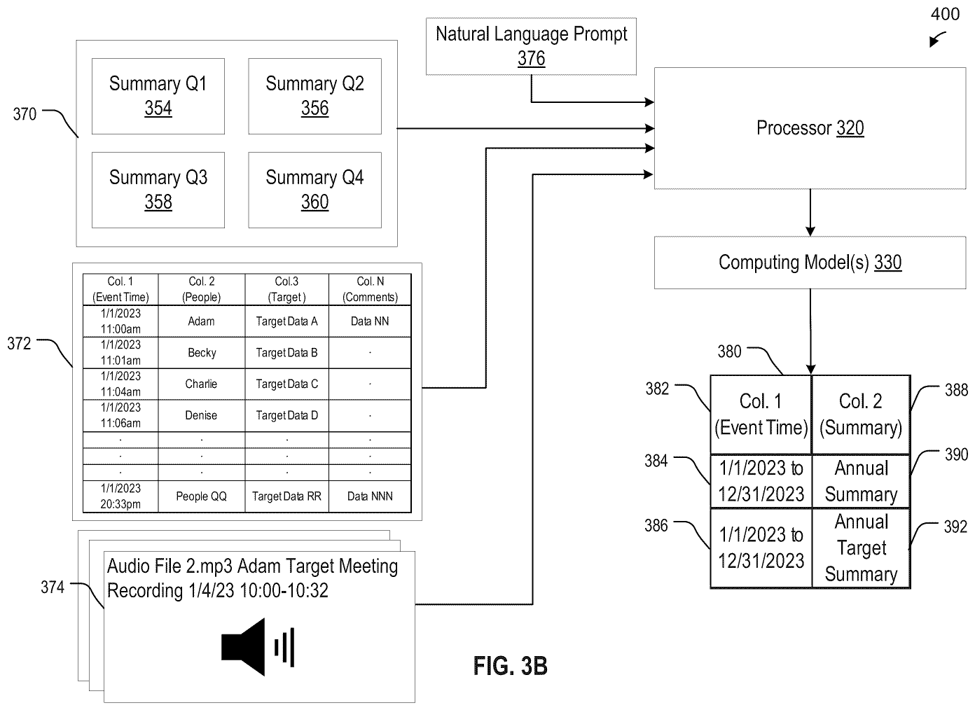

FIG. 3A is an illustrative example workflow for a system 300 to generate a text summary from a plurality of event logs. FIG. 3A is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, a request is received to generate four quarterly summaries for a coding project from the previous year. In some embodiments, the request includes one or more event logs 310, 312, and 314 each comprised of unstructured data. In some embodiments, event log 310 is a plurality of documents such as emails, chats, word documents, and other textual documents relating to the coding project but each lacking an organized format. In some embodiments, event log 312 is a plurality of code commits relating to the coding project. In some embodiments, event log 314 is a plurality of audio files from a plurality of meetings related to the coding project. In some examples, the event logs 310, 312, and 314 each include associated event times. In some embodiments, the event logs 310, 312, and 314 are provided to the processor 320 which generates a series of event logs based on the event times associated with the event logs. In some embodiments, the processor 320 receives one or more time windows of interest, in this case the four quarters of the year, and window the event log series according to the windows. In some embodiments, the processor 320 also receives the natural language prompt 316 from the initial request, for example, to generate quarterly summaries for the coding project. In some embodiments, the processor 320 can extract a time window of interest from the natural language prompt 316. In certain embodiments, the process 320 can extract an entity of interest and/or a subject matter of interest from the from the natural language prompt 316. In some embodiments, the processor 320 provides the underlying unstructured data from the event log series and the natural language prompt for each time window to one or more computing models 330 (e.g., one or more language models, one or more LLMs, etc.) which will generate output 340 including the event time for the text summaries 354, 356, 358, and 360 corresponding to each window of time. In some examples, the text summaries are transmitted to a computing device (e.g., computing device 440).

FIG. 3B is an illustrative example workflow for a system 300 to generate a text summary recursively from a series of previously generated text summaries and a plurality of event logs. FIG. 3B is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, a subsequent request to that received in FIG. 3A is received to generate an annual summary and annual target summary for the coding project. In some embodiments, the four quarterly summaries 354, 356, 358, and 360 are provided as an event log 370 of unstructured data. In some embodiments, event log 372 is provided which includes structured data in the form of a table of various targets for the year corresponding to different team members of the project and comments for the table. In some embodiments, event log 374 includes one or more audio files from meetings with each team member to discuss their target goals for the year. In some embodiments, the event logs 370, 372, and 374 are provided to the processor 320 which generates a series of event logs from the event times associated event logs 370, 372, and 374 and window the time series according to the information in the natural language prompt 376 which is also provided to the processor 320. In some embodiments, the processor 320 can extract a time window of interest from the natural language prompt 316. In certain embodiments, the process 320 can extract an entity of interest and/or a subject matter of interest from the from the natural language prompt 316. In some embodiments, the processor 320 then provides the underlying unstructured and structured data as well as the natural language prompt for the annual summary and annual target summary to one or more computing models 330 (e.g., one or more language models, one or more LLMs, etc.) which generate two text summaries 390 and 392. In some embodiments, the text summaries are transmitted to a computing device (e.g., computing device 440).

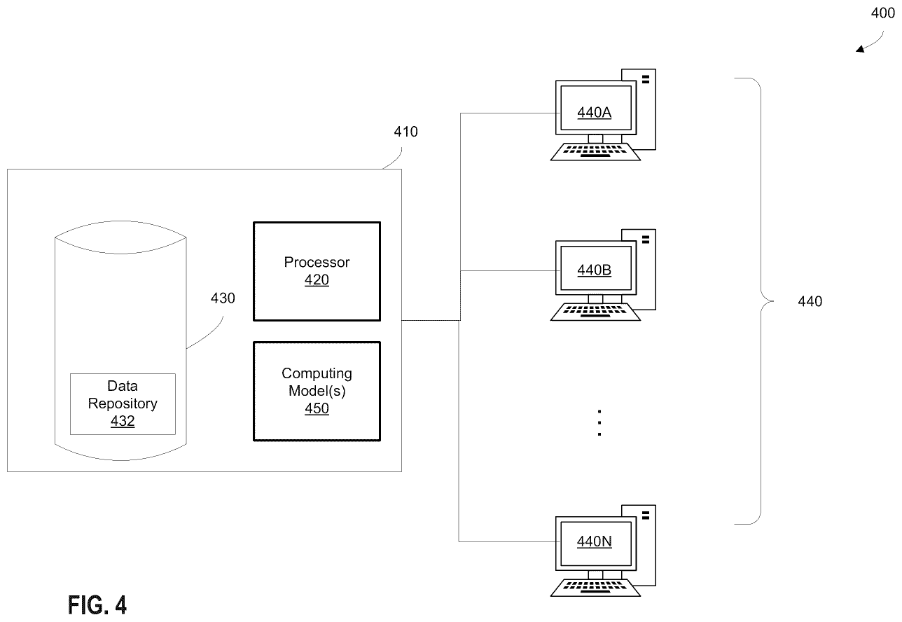

FIG. 4 is an illustrative example of a computing environment 400 for generating text summaries, according to certain embodiments of the present disclosure. FIG. 4 is merely an example. One of the ordinary skilled in the art would recognize many variations, alternatives, and modifications. According to certain embodiments, the computing environment 400 includes a text summary system 410 (e.g., a computing system) and one or more computing devices 440 (e.g., computing device 440A, computing device 440B, . . . , computing device 440N). According to some embodiments, the computing system 410 and/or the computing devices 440 include one or more processors 420 for processing event logs and preparing prompts for the one or more computing models 450 (e.g., language models), and one or more memories 430, which includes a data repository 432.

In certain embodiments, the computing models 450 include one or more large language models such as one or more GPT models, BERT, LaMDA, NeMO LLM, Generate, PaLm, LLaMa, BLOOM, Ernie 3.0 Titan, Claude and/or other LLMs. In certain embodiments, the one or more LLMs are trained or untrained. In some embodiments, the repository 430 can be accessed by the one or more computing devices 440 besides the computing system 410. Although the above has been shown using a selected group of components in the environment 400, there can be many alternatives, modifications, and variations. For example, some of the components are expanded and/or combined. Other components may be inserted into those noted above. Depending upon the embodiment, the arrangement of components may be interchanged with others replaced. Further details of these components are found throughout the present disclosure.

According to certain embodiments, the computing system 410 and/or the processor 420 are configured to receive a plurality of event logs. According to certain embodiments, the one or more received event logs are linked to one or more entities that are connected to the event log in some way. In some embodiments, an entity is a type of semantic object that exists within an ontology such as a user, a person, a team, a task, an initiative, a customer, a geographic location, a building, a project, a workflow, a product, and/or other types of semantic objects linked to the event log. In some examples, an event log has one or a few entities linked to it, such as a certain task that is related to a specific team and/or product. In certain examples, an event log has many entities linked to it such as a national conference with thousands of people attending.

According to certain embodiments, the computing system 410 and/or the processor 420 receives one or more entities of interest, for example, entities relating to the plurality of event logs. In some embodiments, an entity is received as a potential focus of a request for a text summary by a user. In some embodiments, the event logs received could be related to an airline company having delayed flights over the past six months. In some examples, the entity of interest could be a specific location such as a certain airport or group of airports. In certain examples, the entity of interest could be a semantic object related to the event logs such as a specific reason for delayed flight (e.g., weather delay, maintenance delay, ground support delay, etc.), a request to look at where delayed flights were rerouted to, or a request for entities linked to event logs with a delay exceeding 2 hours among a plurality of other possible entities. In some embodiments, multiple entities of interest are received relating to the event logs. In some examples, where multiple entities of interest are received the entities are related to each other in some way. In certain examples, where multiple entities of interest are received, the entities are not related to each other.

According to certain embodiments, the computing system 410 and/or the processor 420 select one or more event logs from the plurality of event logs. In some embodiments, the one or more event logs are selected based at least in part on the one or more entities of interest received. In some embodiments, all and each of the selected one or more event logs are linked to the one or more received predetermined entities of interest.

According to certain embodiments, the computing system 410 and/or the processor 420 generate a series of event logs according to the event times of the one or more selected event logs. In some embodiments, if no event logs are specifically selected, the generated series of event logs will be generated from the one or more received event logs. In some embodiments, the series of event logs is generated by arranging the event logs according to the event time corresponding to the event log respectively. In some examples, the generated series is sequential, first to last or last to first for the event logs.

According to certain embodiments, the computing system 410 and/or the processor 420 receive one or more time windows of interest are received corresponding to one or more of the event logs in the generated series of event logs. In some embodiments, the time window of interest could be a unit of time that includes one or more event logs from the series of event logs. In some examples, the time window of interest is an hour, a few hours, a day, a week, a month, a year, or longer as required by the user. In some examples, the time window is specified with a specific date and/or time range with certain starting and ending points. In certain embodiments, the time windows could be randomly applied to the event logs (e.g., three different windows of three hours length for each window within the last two weeks). In some examples, a first time window is specified to have a first length, a second time window has a second length different than the first length, a third time window is specified with a third length different from the first and second lengths, and so on based on the needs of the user.

According to certain embodiments, the benefit of windowing becomes apparent by considering that the event log series itself is discontinuous meaning the data is collected as unstructured data that is difficult to easily categorize and is not provided on a regular time basis. In some examples, the collection occurs at varying time intervals such as once a week, once a month, or longer, and in the aggregate, it is not easy to containerize these disparate unstructured data sets for analysis. In certain examples, windowing organizes the event logs thereby improving the generated text summaries.

According to certain embodiments, the computing system 410 and/or the processor 420 generate a text summary by applying the one or more computing models 450 (e.g., one or more language models, one or more LLMs, etc.) to unstructured data corresponding to the one or more event logs in the time window of interest. In some embodiments, the prompt to the LLM includes unstructured data underlying the one or more event logs in the window of interest. In some embodiments, the prompt to the LLM includes a combination of structured and unstructured data from the one or more event logs in the window of interest. In some embodiments, the event log series is provided to the LLM as a prompt. In some embodiments, a combination of one or more of the unstructured data, structured data, and/or event log series is provided to the LLM as a prompt. In some embodiments, the prompt to the LLM includes a natural language prompt specifying an entity of interest and or a topic of interest that is the subject of the summary in addition to one or more of the unstructured data, structured data, and/or event log series data. In some embodiments, the output of the computing model is one or more text summaries of the data input with the prompt. In some examples, the text summary is organized as structured data with a format corresponding to the one or more windows applied to the data as part of the prompt. In some examples, the text summary includes unstructured data such as unorganized text in a summary. In some examples, the text summary includes structured data such as organized text (e.g., in a spreadsheet, in a table) and/or a numeric attribute in a summary. In some examples, the text summary includes a combination of unstructured and structured data. In some examples, the text summary includes one or more metrics corresponding to the data input via the prompt. In some embodiments, the text summary includes specific information relating to the specified entity of interest.

In some embodiments, if multiple windows of interest are received, the computing system 410 and/or the processor 420 can generate another text summary corresponding to the additional time window of interest. According to certain embodiments, the computing system 410 and/or the processor 420 can receive a new text summary request. In some examples, the new request is a recursive request to generate a series of text summaries based on the previously generated text summaries and/or additionally identified event logs. In some embodiments, where the previously generated text summaries include unstructured data, the series of summaries form a new series of event logs that are at a higher level than the previously generated series of event logs. In some embodiments, if the previously generated summaries include only structured data the new series of summaries forms a new time series.

According to certain embodiments, performing analysis and generating text summaries for the different windows and different levels of a hierarchical structure provides additional semantic meaning to the user which is absent from a single time series summary. For example, generating a text summary of the cost per minute of a series of event logs may not provide sufficient insight, but aggregating the cost per minute to higher level text summaries such as the cost per hour or cost per day level could. In some embodiments, this is not be apparent until after the original text summaries at the lower level are generated and then recursively aggregated to the higher level. In some embodiments, the generated text summaries remain connected to the event logs and underlying unstructured data and/or structured data. In some examples, this provides the benefit that even throughout multiple recursive iterations it is still possible to access and utilize the underlying data if requested by a user or information consumer.

According to certain embodiments, the computing system 410 and/or the processor 420 receives a plurality of event logs. In some embodiments, at least one event log of the plurality of event logs includes unstructured data and a corresponding event time for the event log.

According to certain embodiments, the computing system 410 and/or the processor 420 generates a series of event logs from the plurality of received event logs. In some embodiments, the series of event logs is generated according to the event times of the plurality of event logs.

According to certain embodiments, the computing system 410 and/or the processor 420 receives a time window of interest corresponding to one or more event logs in the generated series of event logs.

According to certain embodiments, a text summary is generated by applying a language model (e.g., computing model 450, an LLM, etc.) to unstructured data corresponding to the one or more event logs in the time window of interest. In some embodiments, the prompt to the computing model includes one or more of a natural language prompt, unstructured data, structured data, a previously generated text summary, and/or the event log series. According to certain embodiments, the computing system 410 and/or the processor 420 transmits and/or provides the text summary (e.g., a plurality of text summaries) to the computing device 440.

In some embodiments, the repository 430 can include software instructions for generating one or more text summaries according to methods described herein, In certain embodiments, the data repository 432 can store unstructured data, structured data, time series data, event logs, text summaries, summaries, and/or the like. The repository 430 may be implemented using any one of the configurations described herein. The repository 430 may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The repository 430 may be, for example, a single relational database. In some cases, the repository 430 may include a plurality of databases that can exchange and aggregate data by data integration process or software application. In an exemplary embodiment, at least part of the repository 430 may be hosted in a cloud data center. In some cases, a repository 430 may be hosted on a single computer, a server, a storage device, a cloud server, or the like. In some other cases, a repository 430 may be hosted on a series of networked computers, servers, or devices. In some cases, a data repository may be hosted on tiers of data storage devices including local, regional, and central.

In some cases, various components in the environment 400 can execute software or firmware stored in non-transitory computer-readable medium to implement various processing steps. Various components and processors of the environment 400 can be implemented by one or more computing devices including, but not limited to, circuits, a computer, a cloud-based processing unit, a processor, a processing unit, a microprocessor, a mobile computing device, and/or a tablet computer. In some cases, various components of the environment 400 (e.g., computing device 440) can be implemented on a shared computing device. Alternatively, a component of the environment 400 can be implemented on multiple computing devices. In some implementations, various modules and components of the environment 400 can be implemented as software, hardware, firmware, or a combination thereof. In some cases, various components of the environment 400 can be implemented in software or firmware executed by a computing device.

Various components of the environment 400 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

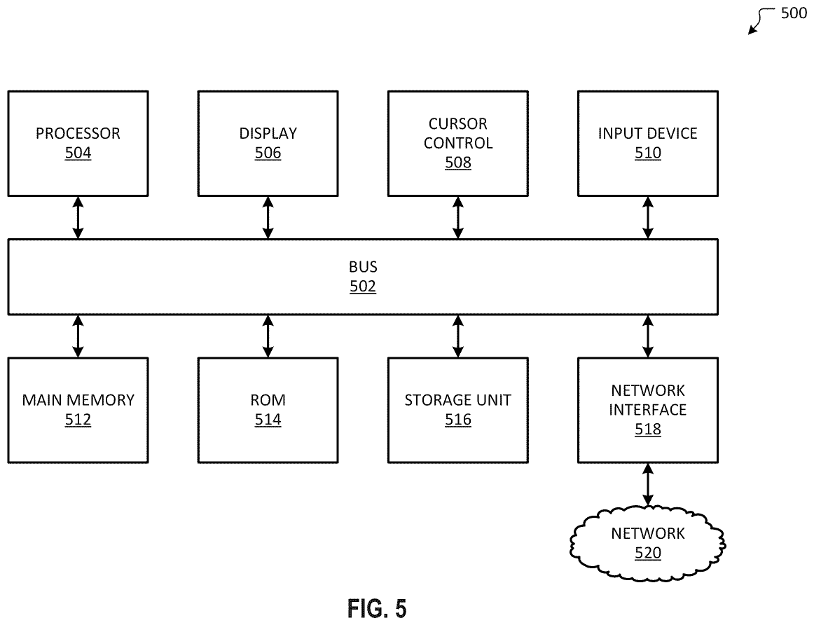

FIG. 5 is a simplified diagram showing a computing system for implementing a system 500 for generating text summaries from event logs in accordance with at least one example set forth in the disclosure. This diagram is merely an example, which should not unduly limit the scope of the claims. One of ordinary skill in the art would recognize many variations, alternatives, and modifications.

The computing system 500 includes a bus 502 or other communication mechanism for communicating information, a processor 504, a display 506, a cursor control component 508, an input device 510, a main memory 512, a read only memory (ROM) 514, a storage unit 516, and a network interface 518. In some embodiments, some or all processes (e.g., steps) of the methods 100, and/or 200 are performed by the computing system 500. In some examples, the bus 502 is coupled to the processor 504, the display 506, the cursor control component 508, the input device 510, the main memory 512, the read only memory (ROM) 514, the storage unit 516, and/or the network interface 518. Certain examples, the network interface is coupled to a network 520. For example, the processor 504 includes one or more general purpose microprocessors. In some examples, the main memory 512 (e.g., random access memory (RAM), cache and/or other dynamic storage devices) is configured to store information and instructions to be executed by the processor 504. In certain examples, the main memory 512 is configured to store temporary variables or other intermediate information during execution of instructions to be executed by processor 504. For examples, the instructions, when stored in the storage unit 516 accessible to processor 504, render the computing system 500 into a special-purpose machine that is customized to perform the operations specified in the instructions. In some examples, the ROM 514 is configured to store static information and instructions for the processor 504. In certain examples, the storage unit 516 (e.g., a magnetic disk, optical disk, or flash drive) is configured to store information and instructions.

In some embodiments, the display 506 (e.g., a cathode ray tube (CRT), an LCD display, or a touch screen) is configured to display information to a user of the computing system 500. In some examples, the input device 510 (e.g., alphanumeric and other keys) is configured to communicate information and commands to the processor 504. For example, the cursor control component 508 (e.g., a mouse, a trackball, or cursor direction keys) is configured to communicate additional information and commands (e.g., to control cursor movements on the display 506) to the processor 504.

According to certain embodiments, a method for generating summaries, the method comprising: receiving a plurality of event logs, at least one event log of the plurality of event logs including unstructured data and a corresponding event time; generating a series of event logs according to event times of the plurality of event logs; receiving a time window of interest corresponding to one or more event logs in the generated series of event logs; generating a text summary by applying a language model to unstructured data corresponding to the one or more event logs in the time window of interest; and transmitting the text summary to a computing device; wherein the method is performed using one or more processors. For example, the method is implemented according to at least FIG. 1, FIG. 2, FIG. 3A, FIG. 3B and/or FIG. 4.

In some embodiments, the method further comprises receiving an entity of interest relating to the plurality of event logs. In certain embodiments, the method further comprises selecting the one or more event logs from the plurality of event logs based at least in part on the entity of interest. In some embodiments, the entity of interest is at least one selected from a group consisting of a person, a team, a task, a project, an event, a situation, and an initiative. In certain embodiments, the time window of interest is a first time window of interest, the one or more event logs are one or more first event logs, and the text summary is a first text summary, wherein the method further comprises: receiving a second time window of interest different from the first time window of interest; selecting one or more second event logs from the generated series of event logs based on the second time window of interest; generating a second text summary by applying the language model to unstructured data corresponding to the one or more second event logs; and transmitting the second text summary to the computing device.

In certain embodiments, the method further comprises generating a third text summary by applying the language model to the first text summary and the second text summary, wherein the third text summary is shorter than a combination of the first text summary and the second text summary; and transmitting the third text summary to the computing device. In some embodiments, the generating a series of event logs comprises: generating a time series of structured data based on the plurality of event logs; and generating the series of event logs based on the time series of structured data and the plurality of event logs. In certain embodiments, the generating a text summary comprises: generating a time series of structured data based on the plurality of event logs; and generating the text summary by applying the language model to the time series of structured data and the unstructured data corresponding to the one or more event logs.

In some embodiments, the generating a text summary further comprises: generating a numerical operation to the time series of structured data to generate a numerical result; and generating an updated text summary based on the numerical result and the generated text summary. In certain embodiments, the event time indicates a single date and time or a date and time range. In some embodiments, the unstructured data includes at least one of audio data or video data.

According to certain embodiments, a system for generating summaries, the system comprising: one or more memories having instructions stored thereon; and one or more processors configured to execute the instructions and further configured to: receive a plurality of event logs, at least one event log of the plurality of event logs including unstructured data and a corresponding event time; generate a series of event logs according to event times of the plurality of event logs; receive a time window of interest corresponding to one or more event logs in the generated series of event logs; generate a text summary by applying a language model to unstructured data corresponding to the one or more event logs in the time window of interest; and transmit the text summary to a computing device.

In some embodiments, the one or more processors are further configured to: receive an entity of interest relating to the plurality of event logs and select the one or more event logs from the plurality of event logs based at least in part on the entity of interest. In certain embodiments, the entity of interest is at least one selected from a group consisting of a person, a team, a task, a project, an event, a situation, and an initiative.

In some embodiments, the time window of interest is a first time window of interest, the one or more event logs are one or more first event logs, and the text summary is a first text summary, the one or more processors is further configured to: receive a second time window of interest different from the first time window of interest; select one or more second event logs from the generated series of event logs based on the second time window of interest; generate a second text summary by applying the language model to unstructured data corresponding to the one or more second event logs; and transmit the second text summary to the computing device. In certain embodiments, the one or more processors are further configured to: generate a third text summary by applying the language model to the first text summary and the second text summary, wherein the third text summary is shorter than a combination of the first text summary and the second text summary; and transmit the third text summary to the computing device.

In some embodiments, the one or more processors, when the generating a series of event logs, are configured to: generate a time series of structured data based on the plurality of event logs; and generate the series of event logs based on the time series of structured data and the plurality of event logs.

In some embodiments, the one or more processors, when the generating a text summary, are configured to: generate a time series of structured data based on the plurality of event logs; generate the text summary by applying the language model to the time series of structured data and the unstructured data corresponding to the one or more event logs; generate a numerical operation to the time series of structured data to generate a numerical result; and generate an updated text summary based on the numerical result and the generated text summary.

In some embodiments, at least one of the event time indicates a single date and time or a date and time range and the unstructured data includes at least one of audio data or video data.

According to embodiments, a method for generating summaries, the method comprising: receiving a plurality of event logs, at least one event log of the plurality of event logs including unstructured data and a corresponding event time; generating a series of event logs according to event times of the plurality of event logs; receiving a time window of interest corresponding to one or more event logs in the generated series of event logs; generating a text summary by applying a language model to unstructured data corresponding to the one or more event logs in the time window of interest; transmitting the text summary to a computing device; receiving an entity of interest relating to the plurality of event logs; and selecting the one or more event logs from the plurality of event logs based at least in part on the entity of interest, wherein the entity of interest is at least one selected from a group consisting of a person, a team, a task, a project, an event, a situation, and an initiative.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for generating summaries, the method comprising:
receiving a plurality of event logs, at least one event log of the plurality of event logs including unstructured data and a corresponding event time;
generating a series of generated event logs according to one or more event times of the plurality of event logs;
receiving a time window of interest corresponding to one or more generated event logs in the series of generated event logs;
generating a text summary by applying a language model to unstructured data corresponding to the one or more generated event logs in the time window of interest; and
transmitting the text summary to a computing device,
wherein the method is performed using one or more processors.

2. The method of claim 1, further comprising:
receiving an entity of interest relating to the plurality of event logs.

3. The method of claim 2, further comprising:
selecting the one or more generated event logs from the plurality of event logs based at least in part on the entity of interest.

4. The method of claim 2, wherein the entity of interest is at least one selected from a group consisting of a person, a team, a task, a project, an event, a situation, and an initiative.

5. The method of claim 1, wherein the time window of interest is a first time window of interest, the one or more generated event logs are one or more first event logs, and the text summary is a first text summary, wherein the method further comprises:
receiving a second time window of interest different from the first time window of interest;
selecting one or more second event logs from the series of generated event logs based on the second time window of interest;
generating a second text summary by applying the language model to unstructured data corresponding to the one or more second event logs; and
transmitting the second text summary to the computing device.

6. The method of claim 5, further comprising:
generating a third text summary by applying the language model to the first text summary and the second text summary, wherein the third text summary is shorter than a combination of the first text summary and the second text summary; and
transmitting the third text summary to the computing device.

7. The method of claim 1, wherein the generating the series of generated event logs comprises:
generating a time series of structured data based on the plurality of event logs; and
generating the series of generated event logs based on the time series of structured data and the plurality of event logs.

8. The method of claim 1, wherein the generating the text summary comprises:
generating a time series of structured data based on the plurality of event logs; and
generating the text summary by applying the language model to the time series of structured data and the unstructured data corresponding to the one or more generated event logs.

9. The method of claim 8, wherein the generating the text summary further comprises:
generating a numerical operation to the time series of structured data to generate a numerical result; and
generating an updated text summary based on the numerical result and the generated text summary.

10. The method of claim 1, wherein at least one of the one or more event times indicates a single date and time or a date and time range.

11. The method of claim 1, wherein the unstructured data includes at least one of audio data or video data.

12. A system for generating summaries, the system comprising:
one or more memories having instructions stored thereon; and
one or more processors configured to execute the instructions and further configured to:
receive a plurality of event logs, at least one event log of the plurality of event logs including unstructured data and a corresponding event time;
generate a series of generated event logs according to one or more event times of the plurality of event logs;
receive a time window of interest corresponding to one or more generated event logs in the series of generated event logs;
generate a text summary by applying a language model to unstructured data corresponding to the one or more generated event logs in the time window of interest; and
transmit the text summary to a computing device.

13. The system of claim 12, wherein the one or more processors are further configured to:
receive an entity of interest relating to the plurality of event logs and
select the one or more generated event logs from the plurality of event logs based at least in part on the entity of interest.

14. The system of claim 13, wherein the entity of interest is at least one selected from a group consisting of a person, a team, a task, a project, an event, a situation, and an initiative.

15. The system of claim 12, wherein the time window of interest is a first time window of interest, the one or more generated event logs are one or more first event logs, and the text summary is a first text summary, the one or more processors is further configured to:
receive a second time window of interest different from the first time window of interest;
select one or more second event logs from the series of generated event logs based on the second time window of interest;
generate a second text summary by applying the language model to unstructured data corresponding to the one or more second event logs; and
transmit the second text summary to the computing device.

16. The system of claim 15, wherein the one or more processors are further configured to:
generate a third text summary by applying the language model to the first text summary and the second text summary, wherein the third text summary is shorter than a combination of the first text summary and the second text summary; and
transmit the third text summary to the computing device.

17. The system of claim 12, wherein the one or more processors, when the generating the series of generated event logs, are configured to:
generate a time series of structured data based on the plurality of event logs; and
generate the series of generated event logs based on the time series of structured data and the plurality of event logs.

18. The system of claim 12, wherein the one or more processors, when the generating the text summary, are configured to:
generate a time series of structured data based on the plurality of event logs;
generate the text summary by applying the language model to the time series of structured data and the unstructured data corresponding to the plurality of event logs;
generate a numerical operation to the time series of structured data to generate a numerical result; and
generate an updated text summary based on the numerical result and the generated text summary.

19. The system of claim 12, wherein at least one of the one or more event times indicates a single date and time or a date and time range and the unstructured data includes at least one of audio data or video data.

20. A method for generating summaries, the method comprising:
receiving a plurality of event logs, at least one event log of the plurality of event logs including unstructured data and a corresponding event time;
generating a generated series of event logs according to one or more event times of the plurality of event logs;
receiving a time window of interest relating to the plurality of event logs;
receiving an entity of interest relating to the plurality of event logs; and
selecting one or more generated event logs from the series of generated event logs based at least in part on the time window of interest and the entity of interest;
generating a text summary by applying a language model to unstructured data corresponding to the one or more generated event logs in the time window of interest;
transmitting the text summary to a computing device;
wherein the entity of interest is at least one selected from a group consisting of a person, a team, a task, a project, an event, a situation, and an initiative;
wherein the method is performed using one or more processors.
